(19) United States
(12) Patent Application Publication
(10) Pub. No.: US 2011/0279044 A1
(43) Pub. Date: Nov. 17, 2011

(54) HIGH EFFICIENCY POWER DRIVE DEVICE ENABLING SERIAL CONNECTION OF LIGHT EMITTING DIODE LAMPS THERETO

(76) Inventor: Fu-Hwa Maiw, Hsin-Tine City (TW)

(21) Appl. No.: 12/081,110

(22) Filed: Apr. 10, 2008

(51) Int. Cl. H05B 37/02

(52) U.S. Cl. 315/186

(57) ABSTRACT

A high efficiency power drive device enabling serial connection of LED lamps thereto, which includes a power source filter circuit, an AC to DC rectifier, a power factor correction circuit and an LED constant current drive circuit. The power factor correction circuit is utilized using the so-called transition mode technique to obtain voltage required by the LED lamps when serially connected, and current control is used to achieve a state whereby the current and voltage are in the same phase. A current control IC and an externally set resistor are further used to eliminate the need to adopt any CPU (central processing unit) while accurately directly controlling the output pulse width of PWM (Pulse Width Modulation).

### BACKGROUND OF THE INVENTION

(a) Field of the Invention

The present invention relates to a high efficiency power drive device enabling serial connection of LED (Light Emitting Diode) lamps thereto, and more particularly to a power drive device which has low cost, is high energy saving, has a long serviceable life and extensive and exhaustive application, and which is applicable for use in connection with a set of LED lamps installed in a lamp when illuminating. The power drive device uses a power source filter circuit to intercept noise signals of the system, when operating, through a common mode and a passive low-pass network to a nodal point where they cancel out and an earth reference potential. An AC (Alternating Current) to DC (Direct Current) rectifier included in the present invention primarily functions to convert alternating current into direct current, and then a power factor correction circuit is utilized using an L6561 chip to achieve a design using the so-called Transition Mode Technique to obtain voltage required by the LED lamps when serially connected, and current control is used to achieve enabling the input current to have a sinusoidal wave form, as well as causing the current and voltage to be in an in-phase state. Finally, a current control IC 9910 is used to eliminate the need to adopt any microprocessor processing by using an externally set resistor, thereby accurately directly controlling output pulse width of a PWM (Pulse Width Modulation), and achieving the specification requirement for actuation of the serially connected LED lamps with constant current to implement power drive control functionality of the LED lamps.

(b) Description of the Prior Art

The rapid development of technology has driven people for a better quality of life and the ever increasing advancement in research and development regarding LED lamp effectiveness and use aspect has already been adopted for application in lamp illumination, and a set of LED lamps compared to a set of traditional lamps is not only characterized in having higher efficiency and energy saving effectiveness, moreover, the serviceable life of traditional mercury lamps is approximately 10,000 hours, whereas the LED lamp has a serviceable life of over 100,000 hours, which clearly shows that the serviceable life of the LED lamp is considerably longer.

Hence, currently, because, the power supply unit used by a set of LED lamps of the prior art is a switching power supply used by a common computer, thus, the design principle thereof is that of a constant voltage constant current device.

However, a variation in the physical characteristic of LED lamps occurs after a long period of use thereof. For example, operating current of the LED lamps gradually rises as the number of hours of use increases, finally resulting in a flicker phenomenon appearing in the LED lamps because of an inadequate output current from the switching power supply, and such phenomenon is often seen in traffic signs using LED lamps at road intersections.

Furthermore, because sets of LED lamps in the current market are limited to using power supply devices that provide low voltage high current output, thus, the majority of arrangements of the LED lamps adopts a parallel connection method, and the passing current produced by the parallel connection is inconsistent and often causes nonuniform brightness to occur in the LED lamps, which at the same time results in an unequal serviceable life of the arranged LED lamps.

In addition, switching power supplies used by computers not only use a great many components and are bulky; moreover, they are only able to achieve a highest efficiency of 85%. Furthermore, because the temperature of the working environment interior of the computer is often excessively high, thereby causing internal hardware to be frequently damaged, thus, if such switching power supplies are used for lamps, then considerable maintenance cost expenditure can be expected by the user.

Hence, the anxieties caused by the impracticalities of high cost, low efficiency and short serviceable life resulting from the switching power supplies used by the common computer and utilized by prior art configurations are issues waiting to be solved.

### SUMMARY OF THE INVENTION

In light of the disappointments resulting from the aforementioned prior art, the present invention develops has developed a high efficiency power drive device enabling serial connection of LED lamps thereto to resolve the shortcoming in the prior art, and the primary objective lies in effectively avoiding the disappointments in the aforementioned power supply system configuration and providing thorough practicability, which not only enables energy to be saved, and for LED lamp efficiency to reach above 92%, moreover, enables brightness of each LED lamp is consistent, and serviceable life is longer, thereby truly achieving a revolutionary product demanded in an age of resource shortages that meets the need for high efficiency, low cost, high energy conservation, practicability and longer serviceable life.

Another objective of the high efficiency power drive device enabling serial connection of LED lamps thereto of the present invention lies in using serially connecting means to connect the LED lamps, and even if the series connected voltage of the LED lamps varies, a current control IC is still able to bring into effect chip characteristics of constant current functionality and high efficiency by means of a sensing resistor, thereby effectively reducing failure rate of the series connected voltage.

In order to achieve the aforementioned and other objectives, the high efficiency power drive device enabling serial connection of LED lamps thereto of the present invention, which is applicable for use in connection with a set of LED lamps installed in a lamp when illuminating, comprises at least one power source filter circuit, which is used to intercept noise signals of the system, when operating, through a common mode and a passive low-pass network to a nodal point where they cancel out and an earth reference potential; an AC to DC rectifier, primary function of which is to convert alternating current into direct current; a power factor correction (PFC) circuit, which increases voltage to an appropriate range for use by the power drive device when the input voltage is less than voltage load; an LED constant current drive circuit, which is a circuit system primarily structured to comprise a current control IC, an IC current sensor (CS), a metallic oxide semiconductor field effect transistor (MOSFET), a resistor and an inductor.

In order to accommodate the power factor requirements of over 30W lamp stabilizers, a ST L6561 chip is used within the PFC circuit.

Dimming modes of the LED constant current drive circuit can be set for analog dimming control and digital dimming control.

In addition, the present invention utilizes the PFC circuit using the ST L6561 chip to achieve the so-called Transition Mode Technique to obtain the voltage required by the LED lamps when serially connected, and uses current control to achieve enabling the input current to have a sinusoidal wave form, as well as achieving the objective of phase equality between the current and voltage. Moreover, a current control IC with serial number 9910 of the LED constant current drive circuit is used to eliminate the need to adopt any microprocessor processing while accurately directly controlling the PWM (Pulse Width Modulation) output pulse width by means of an externally set resistor, which not only enables using serially connecting means to connect the LED lamps, effecting consistency in the brightness of each LED lamp bulb, thereby lengthening serviceable life thereof, moreover, achieves the specification requirement for actuation of the serially connected LED lamps with constant current to implement power drive control functionality of the LED lamps.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an application circuit diagram for transition power factor correction according to the present invention.

FIG. 2 shows a schematic view depicting wave comparison of inductor T1 current and a metallic oxide semiconductor field effect transistor (MOSFET) Q1 in time intervals according to the present invention.

FIG. 3 shows an application circuit diagram of a chip ST L6561 according to the present invention.

FIG. 4 shows a circuit schematic diagram of a current control IC 9910 according to the present invention.

FIG. 5 shows an application circuit schematic diagram of an embodiment according to the present invention.

FIG. 6 shows a logic circuit schematic flow chart of the embodiment according to the present invention.

### DETAILED DESCRIPTION OF THE PREFERRED EMBODIMENTS

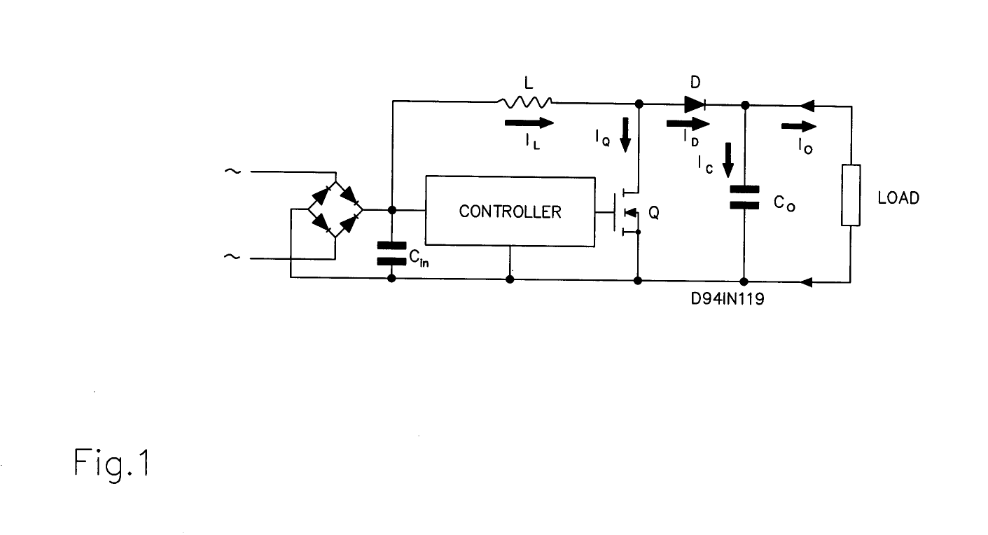

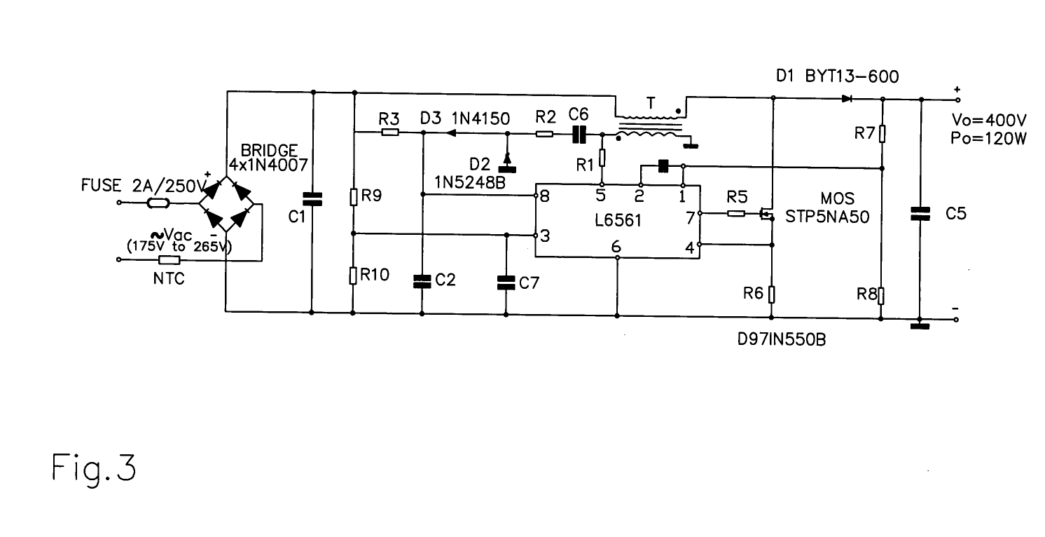

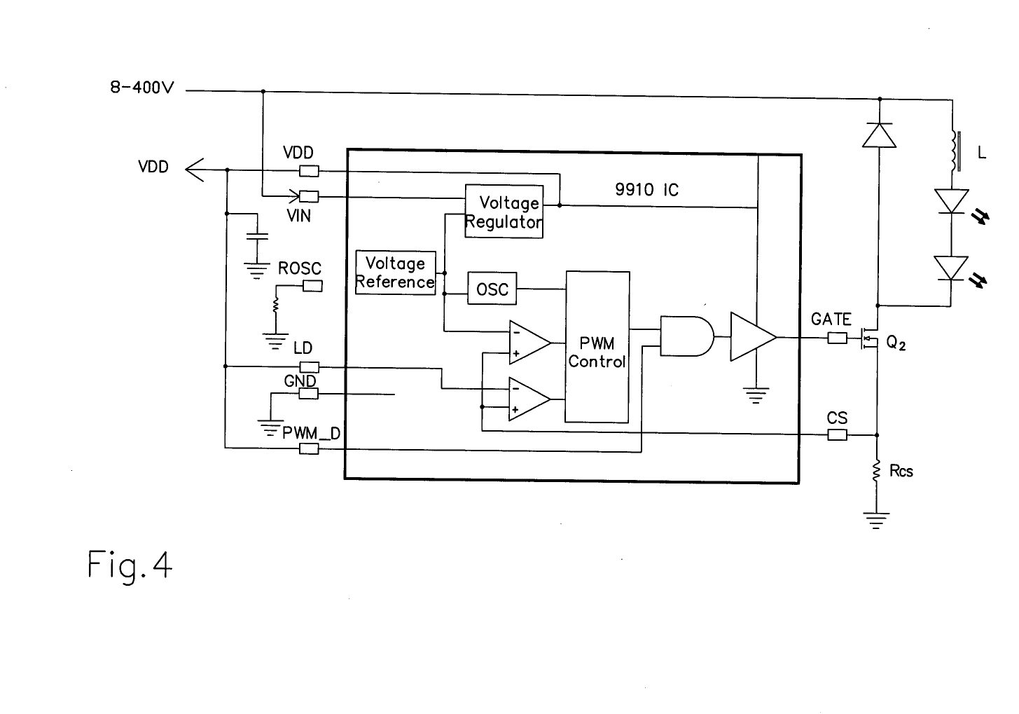

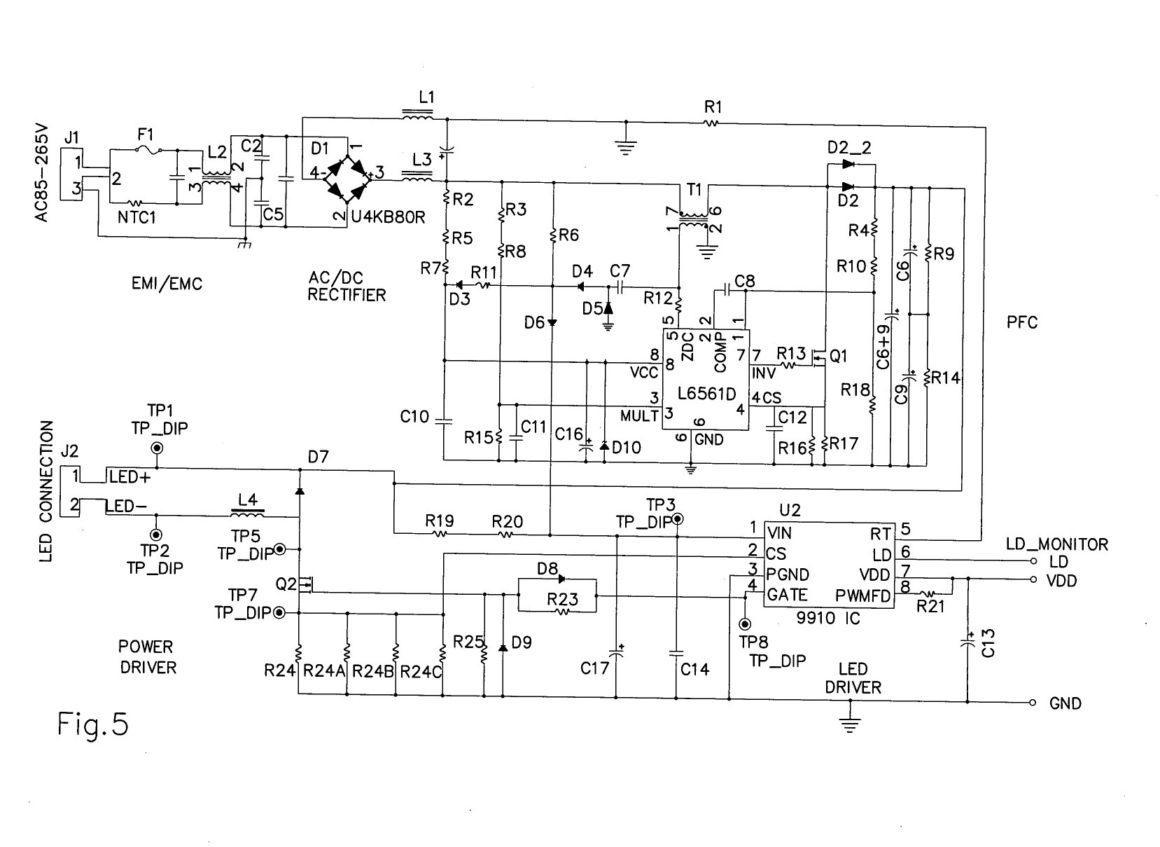

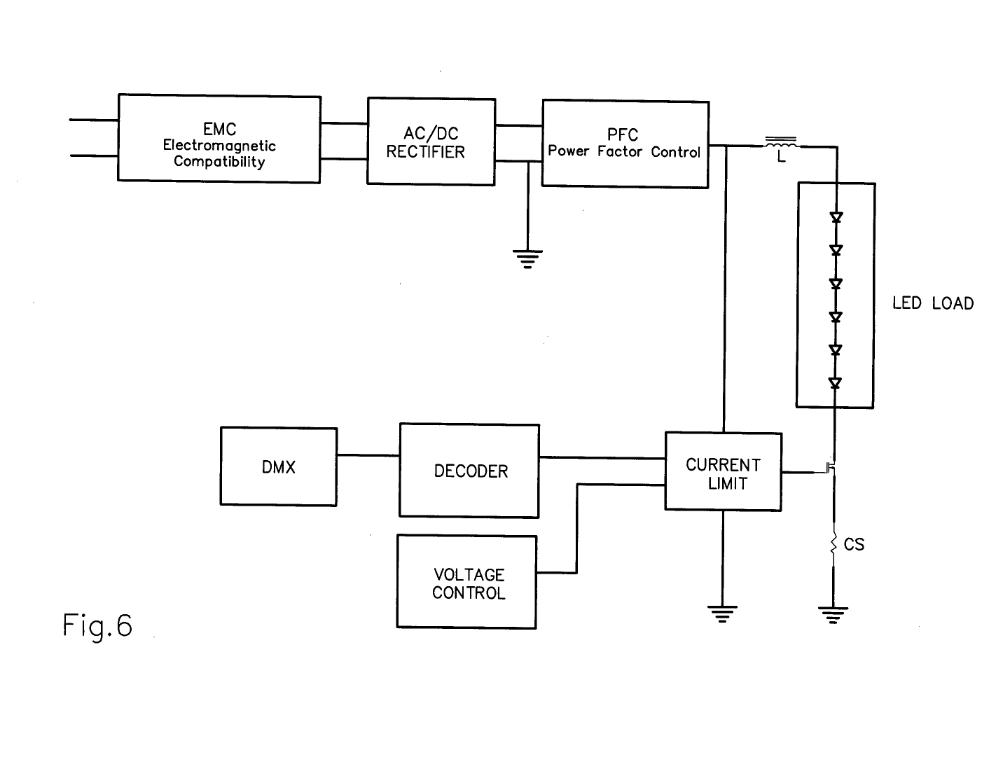

Referring to FIG. 1, FIG. 3 and FIG. 4, FIG. 5 and FIG. 6, which show a high efficiency power drive device enabling serial connection of LED lamps thereto of the present invention, wherein a power drive circuit comprises:

A power source filter circuit EMI/EMC, which primarily intercepts noise signals produced by electric current provided by an alternating current J1 through a common mode and a passive low-pass network to a nodal point where they cancel out and an earth reference potential. Because the power source filter circuit EMI/EMC uses a voltage range compatible with power systems worldwide as the basis for its voltage range, thus, the power source filter circuit EMI/EMC is applicable for use in the power supply system of all countries. Accordingly, no modifications whatsoever are required regardless of the location in the world.

An AC to DC rectifier, which converts alternating current provided by the alternating current J1 into direct current for use thereof using a bridge rectifier U4 KB80R, and the circuitry of the present invention is able to withstand a direct current high voltage of 450V, thereby eliminating the need for a transformer to reduce the voltage, and thus saving on the cost of such a device, while at the same time providing functionality to directly drive the required high-voltage load.

A PFC (Power Factor Correction) circuit, which primarily increases voltage to an appropriate range when the input voltage is less than voltage load, and electric current is used to effect control in order to provide the power drive device with a stable power factor requirement for use thereof.

An LED DRIVE (LED constant current drive circuit), which is a circuit system primarily structured to comprise a current control IC 9910, an IC current sensor (CS), a metallic oxide semiconductor field effect transistor (MOSFET) Q2, a resistor Rcs and an inductor L, and dimming modes can be set for analog dimming control and digital dimming control.

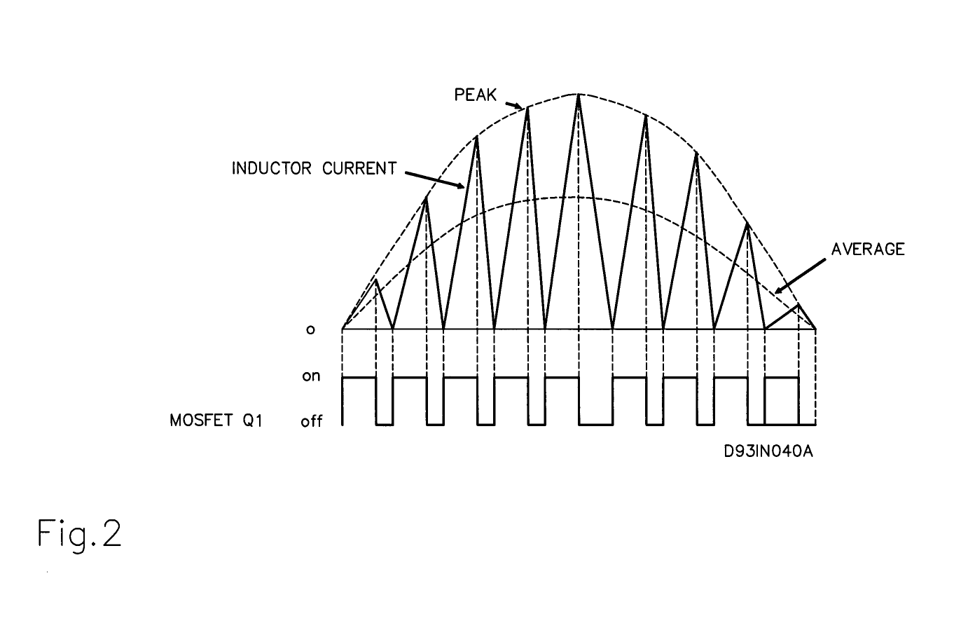

Furthermore, referring to FIG. 2 in conjunction with the remaining drawings, in order to accommodate the power factor requirements of over 30W lamp stabilizers, the present invention is configured with the PFC circuit within the system, and a ST L6561 chip used in the PFC circuit has the following characteristics:

1. Provided with hysteresis under voltage lockout functionality.

2. Low starting current (typical value: 50 uA; guaranteed less than 90 uA), thereby reducing power loss.

3. Error rate of the internal reference voltage is within 1% at 25° C.

4. Apart from being provided with disable functionality, the system can also be closed when needed, thereby reducing damage.

5. Two-stage overvoltage protection.

6. Provided with internal activation and zero current detection functionality.

7. Internally provided with a multiplier, which effects a preferred THD (Total Harmonic Distortion) value for the wide ranging input voltage.

8. Current detection input end is provided with an internal RC (Resistance Capacitance) filter.

9. High-capacity totem pole output stage is able to directly activate a metallic oxide semiconductor field effect transistor (MOSFET).

The present invention utilizes the PFC circuit using the ST L6561 chip, designed with the so-called Transition Mode Technique, to obtain the voltage required by the LED lamps when serially connected, and uses current control to achieve enabling the input current to have a sinusoidal wave form, as well as achieving the objective of phase equality between the current and voltage.

First, after the main alternating current power source has passed through the bridge rectifier U4 KB80R and sent to a step-up converter (see FIG. 1), then switching technology of the step-up converter is used to convert the input voltage to the required output voltage value.

When an error amplifier carries out comparison between a sampling voltage output by the step-up converter and the internal reference voltage and produces a signal which is in direct proportion to the difference between the two. If the bandwidth of the error amplifier is small enough (less than 20 Hz), then the error signal in a half period can be regarded as the direct current value, and the error signal is sent to the multiplier and multiplied by the input rectified sampling voltage. The result of the multiplication is a rectified sine wave, size of the peak value of which is related to the principal voltage peak value and error signal amount.

Output of the multiplier is sent to a “+” terminal of a current comparator, and is a PWM (Pulse Width Modulation) sine wave reference signal. When the voltage (the product of multiplying inductor current and resistance) of an IC current sensor (CS) pin4 of the chip ST L6561 and the voltage at the “+” terminal of the current comparator are equal, then conducting operation of a MOSFET Q1 is cut off.

Based on the above deductions, then inductor T1 current packets are rectified sine waves, and operational process of each half period proves that a fixed conducting time for the system is possible. Inductance effects discharge energy release towards the load from the time when the MOSFET Q1 is cut off to when the inductor T1 current equals zero. When the inductor T1 electric current is zero, then the inductor T1 has no stored energy, and a drain D1 is placed in a floating state, at which time total capacitance of the inductor T1 and the drain D1 produces resonance, and voltage of the drain D1 rapidly drops below an instantaneous line voltage, and a signal again triggers the MOSFET Q1 to conduct, following which a switching period additionally starts.

When conducting, the small voltage crossing the MOSFET Q1 can reduce switching loss and energy loss (loss within the MOSFET Q1) of equivalent capacitance stored in the drain D1.

In addition, (see FIG. 2) using geometric relationship, it can be proved that the inductor T1 current crossing the MOSFET Q1 in a time interval results in the input average current captured from the main circuit being exactly half the peak value of the inductor current wave, and system operation is close to being between a continuous and discontinuous critical mode.

Referring again to FIG. 3 and the remaining drawings, after dividing the output voltage of the bridge rectifier U4 KB80R through the resistances R7, R8, then a first pin1 of the chip ST L6561 obtains a feedback voltage in direct proportion to the output voltage, and, after comparison with an IC internal 2.5V reference potential, the feedback voltage then passes through a compensation network at the two terminals of the first pin1 of the chip ST L6561 and a second pin2 of the chip ST L6561 and outputted to serve as one of the inputs of the internal multiplier. Furthermore, after dividing a 60 Hz supply voltage through resistances R9, R10, then a third pin3 of the chip ST L6561 obtains a sine wave voltage Vs(t), which serves as another input source for the multiplier. Multiplication of these two voltages through the multiplier results in a proportional sine wave reference voltage Vr(t), and the sine wave reference voltage Vr(t) serves as the basis for the power switch cut-off time. When an actuating signal from a seventh pin7 gate of the chip ST L6561 causes conduction through the MOSFET Q1, then the inductor T1 current rises according to a di/dt gradient and flows through a sensing resistance R6, and a voltage V4 obtained crossing the resistance R6 is compared with the reference voltage Vr(t) through the IC current sensor (CS) pin4 of the chip ST L6561. When V4 is greater than Vr(t), then the seventh pin7 of the chip ST L6561 is actuated to cut off the MOSFET Q1.

Apart from providing the chip ST L6561 with a stabilized power supply, moreover, the objective of another group of auxiliary coils is to provide control of switch conducting. When the MOSFET Q1 is cut off, then the main coil polarity is reversed, at which time the auxiliary coil changes into a positive potential, which provides a power source for an eighth pin8 (Vcc) the chip ST L6561 and a reference potential for a fifth pin5 of the chip ST L6561.

When energy from the main coil has been completely released, then the electric potential of the auxiliary coil also drops, thereby causing a drop in the reference potential of the fifth pin5 of the chip ST L6561. Because the internal circuit of the chip ST L6561 at pin5 is a negative edge trigger, thus, when voltage drops to below 1.8V, then the internal circuit is triggered and causes the MOSFET Q1 to conduct. Hence, it can be seen that the wave of the average current obtained by the active PFC is a complete sine wave, and phase thereof is in-phase with the AC power source, thus the PF (Power Factor) value obtained through the active PFC can reach more than 0.98.

Referring to FIG. 4 and the remaining drawings, IC 9910 is a current control IC, and, thus, so long as the current goes through the externally set resistor Rcs, there is no need to adopt any microprocessor processing while accurately directly controlling the PWM output pulse width, which not only enables using serially connecting means to connect the LED lamps, effecting consistency in the brightness of each LED lamp bulb, thereby lengthening serviceable life thereof, moreover, achieves the specification requirement for actuation of the serially connected LED lamps with constant current, and even if the series connected voltage of the LED lamps varies, the current control IC 9910 is still able to bring into effect the chip characteristics of constant current functionality and high efficiency by means of the sensing resistor Rcs.

Furthermore, the present invention utilizes the PFC circuit using the ST L6561 chip, designed with the so-called Transition Mode Technique, to achieve enabling the input current to have a sinusoidal wave form, and for the current and voltage to be in-phase. Moreover, the current control IC 9910 of the LED constant current drive circuit is used to eliminate the need to adopt any microprocessor processing while accurately directly controlling the PWM output pulse width by means of the externally set resistor.

The current control IC 9910 is characterized in that:

1. Directly supports high voltage input, and a broad input voltage range (DC 8V-450V).

2. High system efficiency performance, which is generally over 90%, whereas Switching Power of the prior art is 80%.

3. Provided with a constant current feedback control circuit.

4. Provided with additional digital dimming functionality, additional analog dimming functionality, and programmable PWM oscillation frequency.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A high efficiency power drive device enabling serial connection of LED (light-emitting diode) lamps thereto, comprising:
a power source filter circuit that primarily intercepts noise signals produced by electric current provided by an alternating current through a common mode and a passive low-pass network to a nodal point where they cancel out and an earth reference potential;
an AC (Alternating Current) to DC (Direct Current) rectifier that converts alternating current provided by an alternating current source into direct current for use thereof;
a power factor correction circuit that primarily increases voltage to an appropriate range when the input voltage is less than voltage load, and converts input voltage to the required output voltage value, thereby providing the power drive device with the requirements for a stable power factor for use thereof; a chip used by the power factor correction circuit is designed with the so-called Transition Mode Technique to obtain the voltage required by LED lamps when serially connected, and uses current control to achieve enabling the input current to have a sinusoidal wave form, as well as achieving the objective of phase equality between the current and voltage;
an LED constant current drive circuit that comprises a current control IC (integrated circuit), functioning in conjunction with an externally set resistor, thereby enabling achieving the specification requirement for actuation of LED lamps with constant current without the need to adopt any microprocessor processing, and even if the series connected voltage of the LED lamps varies, the current control IC is still able to bring into effect chip characteristics of constant current functionality and high efficiency by means of the sensing resistor.

2. The high efficiency power drive device enabling serial connection of LED lamps thereto according to claim 1, wherein an error amplifier provided within the chip carries out comparison between a sampling voltage output by a step-up converter and the internal reference voltage, and produces a signal which is in direct proportion to the difference between the two; if the bandwidth of the error amplifier is small enough (less than 20 Hz), then the error signal in a half period is regarded as the direct current value, and the error signal is sent to a multiplier and multiplied by the rectified input sampling voltage, the result of the multiplication is a rectified sine wave, size of the peak value of which is related to the principal voltage peak value and error signal amount.

3. The high efficiency power drive device enabling serial connection of LED lamps thereto according to claims 2, wherein output of the multiplier is sent to a “+” terminal of a current comparator, and is a PWM (Pulse Width Modulation) sine wave reference signal; when the voltage (the product of multiplying inductor current and resistance) of an IC current sensor (CS) of the chip and the voltage at the “+” terminal of the current comparator are equal, then conducting operation of a metallic oxide semiconductor field effect transistor (MOSFET) is cut off.

4. The high efficiency power drive device enabling serial connection of LED lamps thereto according to claims 3, wherein inductor current packets are rectified sine waves.

5. The high efficiency power drive device enabling serial connection of LED lamps thereto according to claims 4, wherein inductance effects discharge energy release towards the load from the time when the MOSFET is cut off to when the inductor current equals zero, and when the inductor electric current is zero, then the inductor has no stored energy, and a drain is placed in a floating state, at which time total capacitance of the inductor and the drain produces resonance, and voltage of the drain rapidly drops below an instantaneous line voltage, and a signal again triggers the MOSFET to conduct, following which a switching period additionally starts.

6. The high efficiency power drive device enabling serial connection of LED lamps thereto according to claim 1, wherein the power source filter circuit uses a voltage range compatible with power systems worldwide as the basis for its voltage range, thus, the power source filter circuit is applicable for use in the power supply system of all countries, accordingly, no modifications whatsoever are required regardless of the location in the world.

7. The high efficiency power drive device enabling serial connection of LED lamps thereto according to claim 1, wherein dimming modes of the LED constant current drive circuit are set for analog dimming control and digital dimming control.
